(19) United States
(12) Patent Application Publication
(10) Pub. No.: US 2026/0146673 A1
(43) Pub. Date: May 28, 2026

(54) Seals For Multi-Surface Sealing

(71) Applicant: Kinetic Pressure Control Ltd., Houston, TX (US)

(72) Inventors: Steven A. Angstmann, Houston, TX (US); Bobby J. Gallagher, Houston, TX (US); Billy J. Gallagher, Houston, TX (US); Sean Laird, Houston, TX (US)

(73) Assignee: Kinetic Pressure Control Ltd., Houston, TX (US)

(21) Appl. No.: 19/177,600

(22) Filed: Apr. 13, 2025

Related U.S. Application Data
(63) Continuation-in-part of application No. 17/789,208, now Pat. No. 12,297,910.
(60) Provisional application No. 62/957,896, filed on Jan. 7, 2020.

(51) Int. Cl. F16J 15/46; F16J 15/10; F16J 15/3236

(52) U.S. Cl. CPC F16J 15/46; F16J 15/104; F16J 15/3236

(57) ABSTRACT

A valve includes a body and a gate disposed in the body. The gate is configured for motion between a position to permit fluid flow through the body and a position to restrict fluid flow through the body. At least one seal is disposed in at least one channel on the gate, wherein the at least one channel is configured to: a) receive a fluid to urge the at least one seal outward from the channel; b) release the received fluid to permit the at least one seal to retract into the channel; and c) cycle between (a) and (b). A method of operating a valve.

### CROSS REFERENCE TO RELATED APPLICATIONS

Continuation-in-Part of U.S. patent application Ser. No. 17/789,208 filed on Jun. 26, 2022, which is a national stage application of International Application No. PCT/US 2021/012331 filed on Jan. 6, 2021, which claims priority from U.S. Provisional Application No. 62/957,896 filed on Jan. 7, 2020. All of the foregoing applications are incorporated herein by reference in their entirety.

### BACKGROUND

This disclosure relates to seals that provide simultaneous sealing at multiple seal surfaces. More specifically, the present disclosure relates to seals that interact with gases and activation pressures to provide simultaneous sealing about seal inner diameter (ID), outer diameter (OD), and face surfaces.

Seals, such as elastomer seals, are used to stop passage of fluid between components placed in proximity. A well-known type of seal is an O-ring, which may be disposed in a groove or channel formed on one of the components and compressively engaged with the other component. In such use, the O-ring may be disposed in an annular space between, for example, nested cylinders or other correspondingly shaped components.

Seals may also be needed to stop fluid passage between one component having a groove or channel to hold the seal, and a flat surface on the proximate component. In some cases, the components may require the ability to move laterally with respect to each other, while maintaining a fluid tight seal and avoiding damage to the seal.

Valves to control the transmission and flow of fluids have been in use for centuries. Gate valves are well known and applied in various industries. In oilfield operations (e.g., fracking applications), gate valves are commonly used to handle fluid flow at each well. Such valves are exposed to extremely harsh fluids (e.g., sand slurries) that significantly reduce the operational life of the gates. A need remains for gate valves with improved seal designs for use in general applications.

### SUMMARY

One aspect of the present disclosure is a valve including a body with a gate disposed therein. The gate is configured for motion between a position to permit fluid flow through the body and a position to restrict fluid flow through the body. At least one seal is disposed in at least one channel on the gate, wherein the at least one channel is configured to: a) receive a fluid to urge the at least one seal outward from the channel; b) release the received fluid to permit the at least one seal to retract into the channel; and c) cycle between (a) and (b).

A method of operating a valve having a body includes channeling a fluid to at least one seal disposed in at least one channel on a gate within the body; wherein the gate is configured for motion between a position to permit fluid flow through the body and a position to restrict fluid flow through the body. The at least one channel is configured to: a) receive a fluid to urge the at least one seal outward from the channel; b) release the received fluid to permit the at least one seal to retract into the channel; and c) cycle between steps (a) and (b).

In some embodiments, a reinforcement is made from a material having a lower resilience than a material used to form the seal body. In some embodiments, the reinforcement comprises a toroid. In some embodiments, the reinforcement comprises metal. In some embodiments, the reinforcement comprises a spring. In some embodiments, an inner and outer wall each comprise a relief, with a reinforcement disposed in each relief. In some embodiments, the seal body comprises an elastomer. Some embodiments further comprise at least one reinforcement disposed in the seal body. In some embodiments, at least one reinforcement disposed in the seal body comprises a ring or an annular spring. Some embodiments further comprise two reinforcements disposed in the seal body. Some seal embodiments comprise a recess between an inner and outer wing. Some embodiments further comprise an O-ring disposed in a recess. In some embodiments, the seal is disposed in a channel in a first component, and a second component is disposed near the seal and the channel to define a passage between the first component and the second component. In some embodiments, the passage is configured to receive a fluid under pressure. In some embodiments, an inner wing is urged into contact with a first wall of a channel and an outer wing is urged into contact with a second wall of the channel. In some embodiments, a channel is in fluid communication with a source of fluid pressure. In some embodiments, the channel comprises a deviated edge to communicate fluid pressure in the passage to the channel. In some embodiments, the channel is in fluid communication with a chamber configured to contain a pressurized fluid therein. In some embodiments, applying fluid pressure comprises applying the pressure to a passage defined between the first and second component so that pressure passes by at least one of the inner and the outer wing to charge the space between the seal and the channel. In some embodiments, the channel comprises a deviated edge to enable passage of a fluid pressure past at least one of an inner wing and an outer wing. In some embodiments, the channel is in fluid communication with a chamber configured to contain a pressurized fluid therein. In some embodiments, a passage is configured to receive a pressurized fluid originating from an actuated charge. In some embodiments, at least one of an inner and outer wall comprises a relief, with a reinforcement disposed in the relief. In some embodiments, a seal comprises at least one reinforcement disposed in the seal body.

### BRIEF DESCRIPTION OF THE DRAWINGS

FIG. 1A shows a plan view of an example embodiment of a seal according to this disclosure.

FIG. 1B shows a cross-section of the uninstalled seal along section line 1B-1B′ in FIG. 1A.

FIG. 1C shows an enlarged view of a cross-section of the seal indicated in the detail of FIG. 1B.

FIG. 2 shows a cross-section of another embodiment of a seal according to this disclosure.

FIG. 3 shows an embodiment of a seal according to this disclosure installed in sealing engagement in an intended use of the seal.

FIG. 4 shows another embodiment of a seal 10 according to this disclosure.

FIG. 5 shows a cross-section of another embodiment of a seal 10 according to this disclosure.

FIG. 6 shows another embodiment of a seal 10 according to this disclosure.

FIG. 7A shows a cross-section of a seal embodiment according to this disclosure.

FIG. 7B shows another cross-section of the seal embodiment of FIG. 7A.

FIG. 8 shows an oblique view of a valve embodiment according to this disclosure.

FIG. 9 shows a view of a gate cartridge in a valve embodiment according to this disclosure.

FIG. 10A shows a schematic of a valve embodiment in an open position according to this disclosure.

FIG. 10B shows the valve of FIG. 10A in a closed position according to this disclosure.

FIG. 11 shows an oblique transparency of valve embodiment according to this disclosure.

FIG. 12 shows a cross-section view of a valve embodiment according to this disclosure.

FIG. 13 shows a plan view cutaway view of a valve embodiment according to this disclosure.

FIG. 14 shows a schematic of a valve spool embodiment according to this disclosure.

FIG. 15 shows a schematic of a valve embodiment with a removable end cap according to this disclosure.

FIG. 16 shows a plan view cutaway view of another valve embodiment according to this disclosure.

FIG. 17 shows a valve embodiment disposed in a fluid system according to this disclosure.

### DETAILED DESCRIPTION

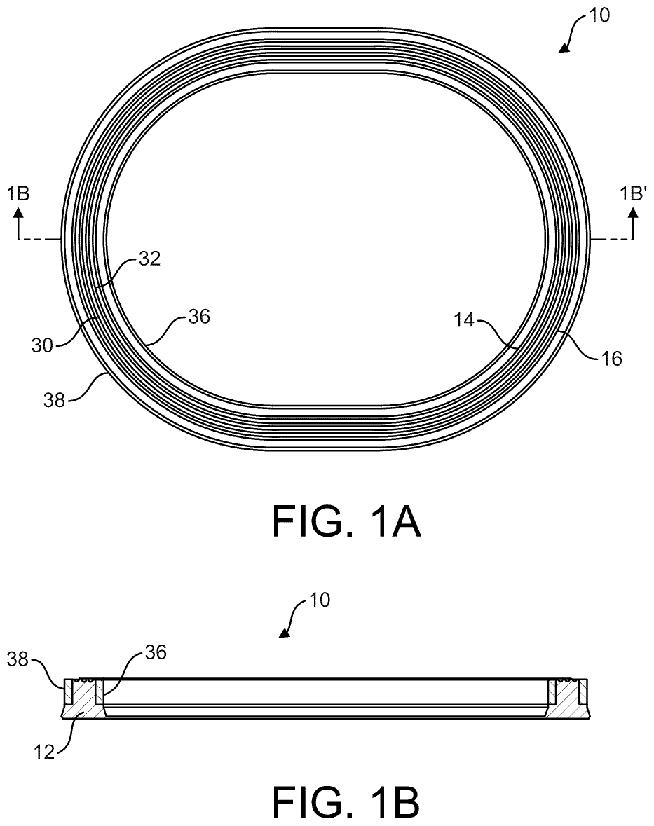

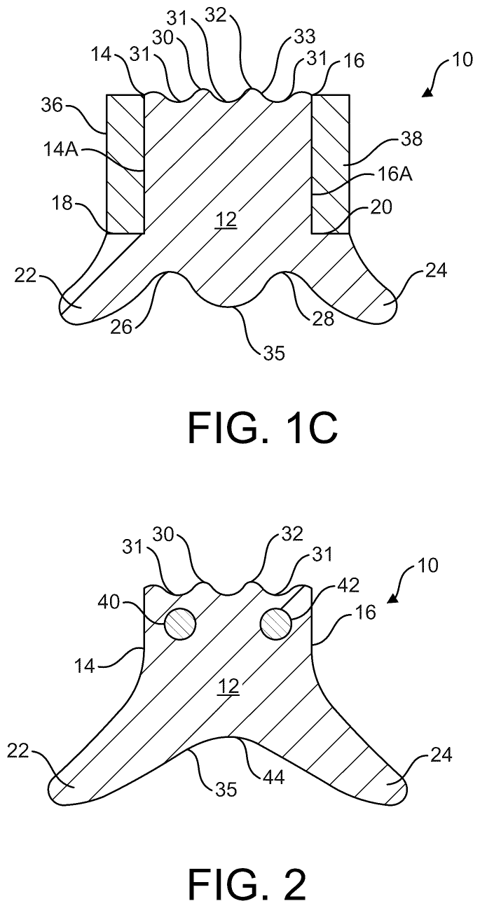

FIG. 1A shows a plan view of an example embodiment of a seal according to this disclosure. The seal 10 may be shaped as an annular ring. The embodiment in FIG. 1A may have an oval or “racetrack” configuration. Embodiments of the seal 10 can be implemented with various dimensions along either or both the major axis and the minor axis (e.g., some embodiments may also be implemented in circular configuration). It will be appreciated by those skilled in the art that the seal 10 according to this disclosure may be formed from conventional materials suitable for the desired application as known in the art (e.g., resilient materials: elastomers: rubber compounds, synthetic elastomeric materials; or composites, etc.). FIG. 1B shows a cross-section of the seal 10 along section line 1B-1B′ in FIG. 1A. The seal 10 includes a centrally disposed body 12, which can vary in height (thickness) depending on the desired application for the seal 10.

FIG. 1C shows an enlarged view of a cross-section of the seal 10 indicated in detail B of FIG. 1B. One side of the seal 10 forms an inner diameter wall 14 and the opposite side forms the exterior diameter wall 16. The positions of the respective walls 14, 16 with reference to the seal 10 are shown in FIG. 1A. Each wall 14, 16 extends from the top surface 33 of the seal 10 toward the bottom surface 35 of the seal 10, forming a smooth annular surface. The lower section of each wall 14, 16 may extend outward, respectively, forming an inner ledge or shoulder 18 and an outer ledge or shoulder 20. Below the inner shoulder 18, the lower body portion of the seal 10 defines a sloping surface extending outward (laterally) from the body 12 of the seal 10 to form an inner wing 22. Similarly, the lower body portion of the seal 10 extending from the outer shoulder 20 defines a sloping surface extending outward (laterally) from the body 12 of the seal 10 to form an outer wing 24. The bottom surface 35 of the seal 10 may comprise a pair of concentric (with reference to the entire seal 10) recesses or grooves 26, 28 extending along the entire loop of the seal, shown in FIG. 1C as an indentation or recess adjacent to each wing 22, 24. The recesses or grooves 26, 28 enable each wing 22, 24 to have flexibility to spread outward or compress inward (laterally) depending on the forces applied to the seal 10 (such forces further described below). A tip of each wing 22, 24 may be shaped to provide effective sealing with minimal surface contact area of each wing with respect to a surface to which the wings 22, 24 are intended to seal, as further explained herein.

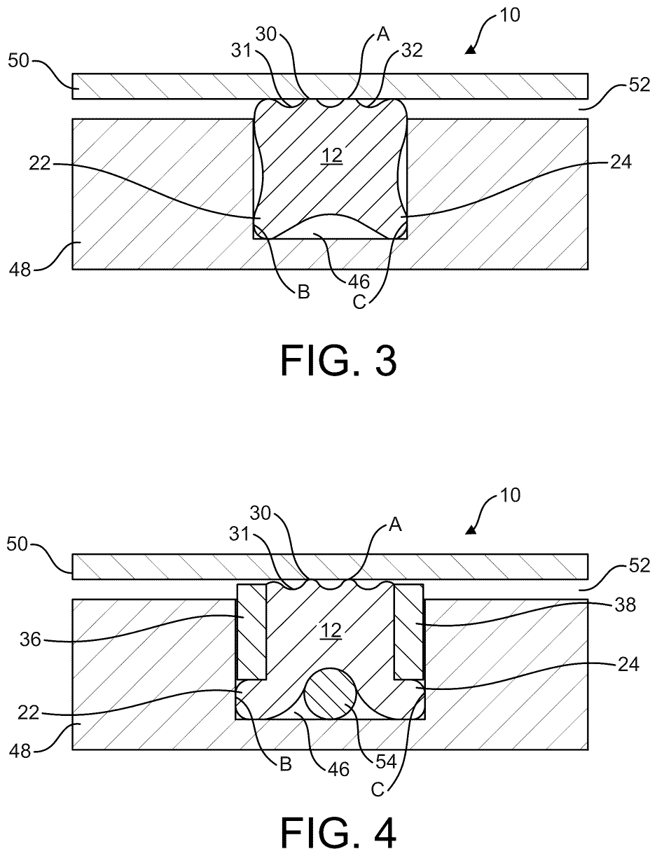

In some embodiments, the seal 10 includes one or more raised portions 30, 32 extending from the upper seal surface 33. Each raised portion 30, 32 may be formed as a ring extending along the entire loop of the upper seal surface 33. Example positions of the raised portions 30, 32 with reference to the entire seal 10 are shown in FIG. 1A. In some embodiments, the upper surface 33 may also be configured with corresponding recessed portions 31 formed as grooves, recesses or trenches running along the entire loop of the upper surface 33. When the seal 10 is installed in an application wherein the raised portions 30, 32 contact another surface in a compressive sealing engagement (e.g., see FIG. 3), the recessed portions 31 provide space for the material of the raised portions 30, 32 to be compressed and displaced.

An inner element 36, e.g., a structural reinforcement, is disposed in a relief 14A formed on the inner circumference of the seal 10. The inner element 36 is configured to abut against the surface of the inner wall 14, its upper end being flush with the top edge of the seal 10 wall and disposed on the inner shoulder 18 at its lower end. An outer element 38, e.g., a structural reinforcement, is fitted over the seal 10 in a relief 16A formed on the outer circumference, its upper end being flush with the upper surface 33 and disposed on the outer shoulder 20 at its lower end. In some embodiments, the upper end of the inner 36 and/or outer 38 elements may be slightly recessed from the upper surface 33. “Upper” and “lower” as used in this description mean only the orientation with reference to the drawing figures and are not intended to limit the physical orientation of the seal 10 in any application for the seal 10. The inner and outer elements 36, 38 may each comprise a solid annular ring or a spring (e.g., shaped as a toroid) respectively sized to conform to the ID and OD of the body 12 (See FIG. 1B). The elements 36, 38 may be formed from conventional materials suitable for the desired application as known in the art. In some embodiments, the inner and/or outer elements 36, 38 may be formed from harder or more rigid materials (e.g., metal, hard thermoplastic, etc.) than the material used to form the seal body 12. The inner and outer elements 36, 38 may be affixed to the seal body 12 by any suitable means as known in the art (e.g., heat fusing, adhesives, interference fit, etc.). In some embodiments, the elements 36, 38 may be molded into the seal body 12 using manufacturing techniques as known in the art.

FIG. 2 shows a cross-section of another embodiment of a seal 10 according this disclosure. The seal 10 may comprise a pair of rings 40, 42 embedded within the seal body 12. The rings 40 are disposed near the upper surface of the seal 10, with one ring 40 placed close to the inner wall 14 and the other ring 42 placed close the outer wall 16. The rings 40, 42 may be formed from a less resilient material than the seal body 12 such as metal or hard plastic and may be formed as a one-piece or multi-piece loop extending along the entire loop of the seal 10. In some embodiments, the rings 40, 42 comprise metallic springs, e.g., made from spring metal such as phosphor bronze. The rings 40, 42 may be molded within the seal 10 during fabrication of the seal 10 in any manner known in the art. The rings 40, 42 may provide additional structural support to the seal 10 and may provide resistance to seal extrusion in certain implementations (further described below). The bottom surface 35 of the seal 10 may be configured with a single groove 44 running along the entire loop of the seal, depicted as an indentation or recess disposed symmetrically between the wings 22, 24.

FIG. 3 shows an embodiment of a seal 10 according to this disclosure installed in sealing engagement in an intended use of the seal 10. FIG. 3 shows a cross-section of the seal 10 corresponding to the cross section of FIG. 1C as installed within a seal groove or channel 46 formed in a first component 48. The seal 10 is shown compressed between the first component 48 and a second component 50. The first 48 and second 50 components represent an article of manufacture with the components disposed close to one another yet providing a passage, orifice, or separation 52 otherwise allowing fluid (e.g., liquid and/or gas) flow in either direction absent the presence of the seal 10 as shown. It will be appreciated that such a configuration to seal such as passage is well known in articles of manufacture. As installed, the seal 10 is compressed within the channel 46 such that the top surface of the seal 10 contacts the second component 50. The one or more raised portions 30, 32 on the seal 10 are compressed against the second component 50 surface, forming a sealing face engagement. The inner 22 and outer 24 wing sections respectively spread outward from the center of the seal body 12, forming a radial sealing engagement B, C against the side walls of the groove or channel 46. As shown in FIG. 3, the seal 10 provides face A and radial B, C sealing against fluid passage along the separation 52. Although shown in a cross-sectional view in FIG. 3, it will be appreciated that the seal 10 is formed as an annular ring or loop in its entirety, similar to what is shown in FIG. 1A.

FIG. 4 shows another embodiment of a seal 10 according to this disclosure. An O-ring 54 may be disposed at the bottom of the seal 10, residing between the wings 22, 24. The O-ring 54 aids spread the wings 22, 24 outwardly from the seal body 12 to seal against each side of the channel 46. The present embodiment of the seal 10 may also be configured with inner 36 and outer 38 elements as shown in FIG. 1C. In addition to providing structural support, the inner 36 and outer 38 elements may reduce or prevent wear on the seal 10 edges and resist extrusion of the seal 10 from the channel 46 in applications where the first 48 and/or second 50 component is configured for movement in relation to the other component (e.g., when the installation is such that the second component 50 is configured for sliding motion (left to right in FIG. 4) over the first component 48).

FIG. 5 shows a cross-section of another embodiment of a seal 10 according to this disclosure. A seal 10 is installed within a channel 46 between a first component 48 and a second component 50. In this embodiment, the first component 48 includes a chamber 56 formed therein and in fluid communication with the recess or channel 46 through a port 58. The chamber 56 may provide a sealed space configured to contain a fluid (e.g., nitrogen or other gas) under pressure. It will be appreciated by those skilled in the art that the chamber 56 may be formed in the first component 48 by any suitable means as known in the art (e.g., a machined cavity having a sealing end cap, by casting, by 3D printing, etc.). In some embodiments, the chamber 56 may be pressurized by injecting a suitable fluid, e.g., gas, through a nozzle 60 on a threaded end cap 62, which end cap 62 closes the chamber 56 at one end as shown in FIG. 5. In some embodiments, a pressurized gas cartridge 64 may be used to fill the chamber 56 with any desired gas as known in the art. In some embodiments, the chamber 56 may be pressurized with a suitable liquid (e.g., oil or grease). In some embodiments, a setting or curing filler compound (e.g., epoxy or thermoplastic) may be used to pressurize the chamber 56 and thereby energize the seal 10.

When the seal 10 is installed in the channel 46, the wings 22, 24 on the seal 10 extend out to simultaneously contact both sides of the channel 46. Once fluid pressure (shown by arrow 66) is applied to the space in the channel 46 underneath the seal 10 e.g., through the port 58, the seal 10 moves upward as a result of the fact that the channel 46 side walls are closed to fluid flow by the wings 22, 24 on the seal body 12. The higher the gas pressure 66, the greater the sealing forces applied to the wings 22, 24. As such, the wings 22, 24 provide that the seal 10 is pressure activated and the seal 10 is thereby energized.

As shown in FIG. 5, the raised portion(s) 30 at the top of the seal 10 also provide(s) a seal against the face A by reason of engagement with the second component 50. Sealing by the face A may also be activated by the pressurized gas 66 acting on the area beneath the seal 10 in the recess or channel 46. In embodiments such as shown in FIG. 4, the inclusion of an O-ring 54 between the wings 22, 24 may provide seal activation before fluid pressure 66 is applied, thereby providing a low-pressure sealing capability as well as higher pressure capability after fluid pressure activation of the seal 10.

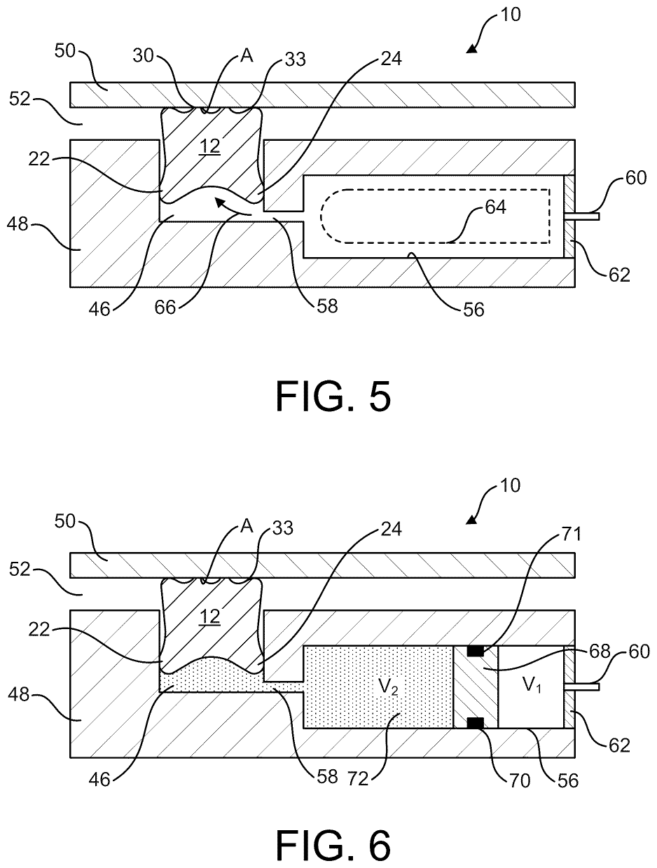

FIG. 6 shows another embodiment of a seal 10 according to this disclosure. The seal 10 is shown installed within a channel 46 to provide sealing between a first 48 component and a second 50 component. As with the embodiment shown in FIG. 5, the first component 48 includes a chamber 56 in fluid communication with the channel 46 through a port 58. In the present embodiment, the chamber 56 includes a piston 68 configured to slide within the chamber 56, separating the chamber into two volumes V1, V2. With a cylindrical chamber 56, the piston 68 comprises a disc or flat cylinder having an O-ring 70 disposed in a groove 71 formed on the circumference of the piston 68. The piston 68 may be formed of any suitable material. In some embodiments, the chamber 56 may be sealed using metal-to-metal seals. Volume V1 of the chamber 56 may be pressurized by injecting a suitable fluid, e.g., gas through the nozzle 60 on the end cap 62 sealing the chamber at one end. Fluid pressure may be provided, e.g., by a pressurized gas cartridge (64 in FIG. 5), or any other suitable means as described herein or as depending on the application. On the other side of the piston 68, volume V2 of the chamber 56 may contain a semi-solid compound 72 (e.g., suitable grease or other semi-solid compound as known in the art). The volume V2 may be pre-loaded with the compound 72 during assembly of the structure. Use of the compound 72 in volume V2 may provide an advantage in some implementations where higher pressures need to be applied to activate the seal 10 since the compound 72 is less prone to leakage than, for example, liquid or gas.

Although the seals 10 in FIGS. 5 and 6 are shown as energized (i.e., with the pressurized gas/compound acting on the space beneath the seal), the seals may also be implemented in configurations where the seals are unpressurized. A seal 10 may be placed to initially sit in the channel 46 without application of the pressurized gas 66 or compound 72. In such applications, the seal 10 provides sealing against both sides of the channel 46 through the wings 22, 24, without the face A being in contact with the second component 50. Then, at a subsequent time, fluid under pressure, e.g., the gas 66 or compound 72, can be pressurized to act on the space beneath the seal 10. Since the channel 46 sides are closed, the seal 10 will then move upward to engage the face A with the second component 50, establishing a seal on face A. It will be appreciated that the pressures placed on the face A and sides (e.g., wings 22, 24) of the seal 10 could be different depending on the implementation. Control of these pressures allows seal by the face A to be maintained as desired. It will also be appreciated by those skilled in the art that some embodiments may be configured with conventional electronics and software to automatically and autonomously pressurize the chamber 56 to energize the seals 10 to establish a face seal at face A at a desired time or under certain conditions.

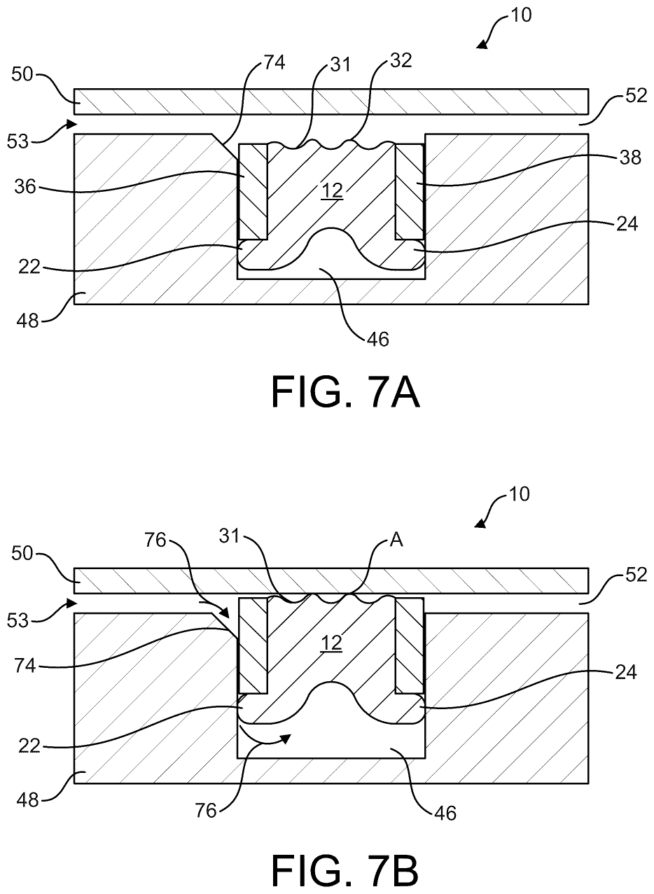

FIG. 7A shows a cross-section of another embodiment according to this disclosure. A seal 10 is installed to sit within a channel 46 in an unpressurized state. The first component 48 is configured wherein the channel 46 has a deviated edge 74. Embodiments may be implemented with the deviated edge 74 comprising: a taper descending into the channel 46, one or more slots running along the surface of the edge, or porting formed at the edge. The deviated edge 74 can be formed on either or both sides of the channel 46. In the unactuated state, fluid pressure on the space beneath the seal 10 is equal to the fluid pressure in the separation 52 between the first 48 and second 50 components. In this implementation, a structure (not shown) comprising the first 48 and second 50 components is designed such that fluid pressure in the separation 52 undergoes a significant and rapid increase under certain conditions. Such conditions may comprise, for example, ignition of a charge 53 generating a gas expanding into the separation 52.

FIG. 7B shows such a high-pressure gas (arrow 76) traversing the deviated edge 74 and moving into the channel 46. The flexible wing 22 on the seal 10 permits the high-pressure gas 76 to fill space in the channel 46 beneath the seal 10. The rapid increase in gas pressure acting on the space beneath the seal 10 urges the seal 10 upward in the channel 46 to engage the seal face A against the second component 50, thereby blocking passage of the gas 76 to the other side of the seal 10. After a seal is established by energizing the seal 10, the gas pressure in the channel 46 beneath the seal 10 urges the seal 10 into contact with the second component, thereby maintaining a fluid-tight seal between the first component 48 and the second component 50. Any of the disclosed seal 10 embodiments may be used as shown in FIGS. 7A and 7B for such activation by application of pressure in the passage 52.

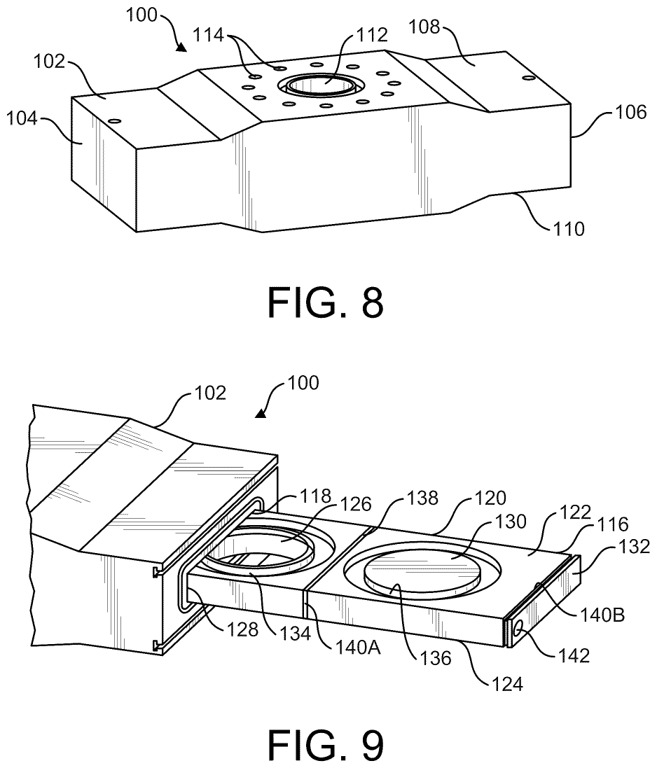

FIG. 8 shows a valve 100 embodiment according to this disclosure. The valve 100 has a main body 102, a first end 104, a second end 106, a first surface 108, and a second surface 110 opposite the first surface. A through bore 112 traverses through the body 102, providing an open passage between the first surface 108 and the second surface 110. Although the embodiment of FIG. 8 shows the through bore 112 configured as a cylindrical opening, the bore may be configured in other geometrical shapes as desired for the application (e.g., oval, octagonal, etc.). The body 102 may be formed of any suitable material depending on the application (e.g., metal, composites, plastics, synthetic materials, etc.). Although FIG. 8 shows an embodiment configured with a generally planar body 102 design, embodiments may be implemented with bodies comprising other geometrical designs more suitable for the desired application.

Some valve 100 embodiments may be configured with threaded holes 114 formed on each surface 108, 110 to receive mounting bolts for mounting of the valve 100 onto a fluid transmission system as known in the art (see FIG. 17). Embodiments may also be configured with the holes 114 passing through the entire body 102 for engagement of the valve 100 to flange units using extended length bolts. It will be appreciated by those skilled in the art that other embodiments may be configured for disposal of the valve 100 onto fluid lines or systems in various fashions depending on the application (e.g., welded onto a line, affixed with clamps, etc.).

FIG. 9 shows a view of a valve 100 embodiment according to this disclosure. The valve 100 is shown with a gate 116 extending out of a slot 118 formed within the body 102. In this embodiment, the gate 116 is configured as a rectangular-shaped planar body 120 with a first surface 122 and a second surface 124. The gate 116 has an opening 126 formed near a first end 128. The opening 126 is preferably shaped to coincide with the geometric shape of the through bore 112 formed in the valve 100 body. The gate 116 provides a solid surface area 130 near a second end 132. FIG. 9 shows the opening 126 surrounded by a seal channel 134. The other end with the solid surface area 130 also has a seal channel 136 formed thereon. Although not shown in FIG. 9, the second surface 124 of the gate 116 is configured with matching seal channels 134′, 136′. In essence, the first surface 122 of the gate 116 is a mirror image of the second surface 124.

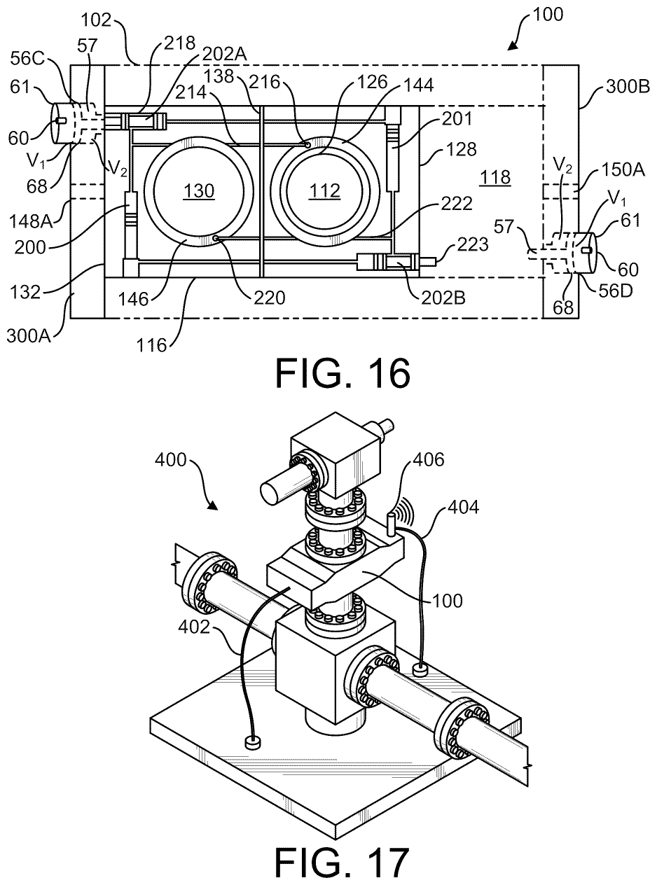

The gate 116 may be formed of any suitable material depending on the application (e.g., metal, composites, plastics, synthetic materials, etc.). As shown in FIG. 9, the gate 116 is disposed in the slot 118, which forms a passage transverse to the through bore 112 along the longitudinal axis of the valve 100 body 102 (see FIGS. 11,12). The gate 116 is formed to fit within the slot 118 at a close tolerance yet allowing the gate to move or slide within the slot as described below. As depicted in FIG. 9, the gate 116 is configured for easy insertion and extraction from the slot 118, akin to a cartridge in a player. This provides a notable advantage compared to conventional valve designs, which typically require removal of the entire valve for repair or refurbishment. Some embodiments may be implemented with a seal or band 138 (e.g., a rubber band) disposed in a groove 140A formed on the gate 116 surface near the center to provide a wiper for the internal surface of the slot 118 as the gate moves back and forth therein. Embodiments may also be implemented with additional wiper bands or seals disposed in other grooves 140B on the gate 116. FIG. 9 also shows the gate 116 configured with a threaded port 142 at one end (further described with respect to FIGS. 13, 16).

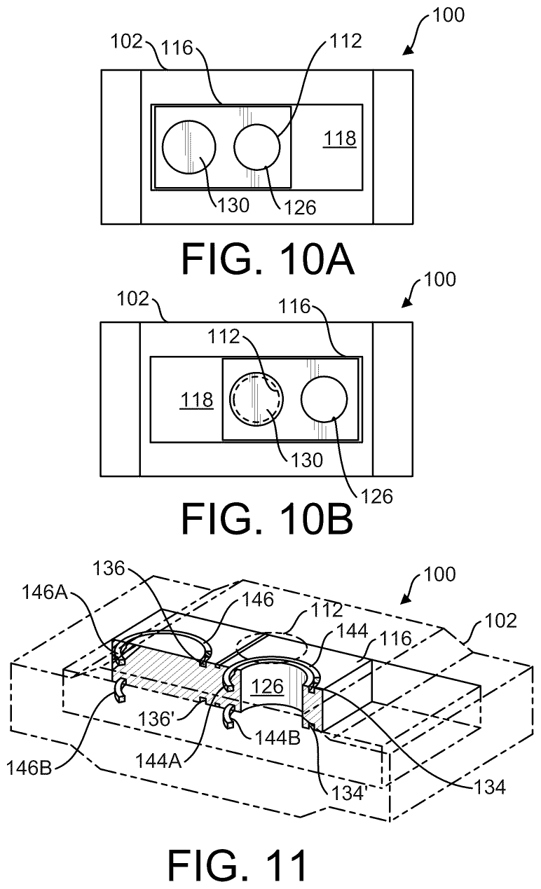

FIG. 10A shows an overhead cutaway schematic of a valve 100 embodiment of this disclosure. The gate 116 is shown in the open position, with the opening 126 coincident and aligned with the through bore 112. In this open position, any fluid traversing the through bore 112 from either the first surface 122 or the second surface 124 is free to flow through the gate 116 opening 126 and in-out through the valve 100.

FIG. 10B shows the valve 100 of FIG. 10A with the gate 116 in the closed position. When the gate 116 is moved (as described below) to the other end of the slot 118 compared to FIG. 10A, the solid surface area 130 of the gate 116 fully covers the through bore 112, preventing fluid passage therethrough.

Turning to FIG. 11, a transparency view of a valve 100 embodiment according to this disclosure is shown. The gate 116 is shown in the open position, as described with respect to the embodiment of FIG. 10A. In this embodiment, the gate 116 is configured with a first seal assembly 144 disposed at the gate opening 126 and a second seal assembly 146 disposed at the solid surface area 130 (see FIG. 9). First seal assembly 144 includes a first seal 144A disposed in the channel 134 formed on the first surface 122 of the gate 116, and a second seal 144B disposed in a mirroring channel 134′ formed on the second surface 124 of the gate (see FIG. 9). The second seal assembly 146 likewise includes a first seal 146A disposed in the channel 136 formed on the first surface 122 of the gate 116 and a second seal 146B disposed in a mirroring channel 136′ formed on the second surface 124 of the gate (see FIG. 9).

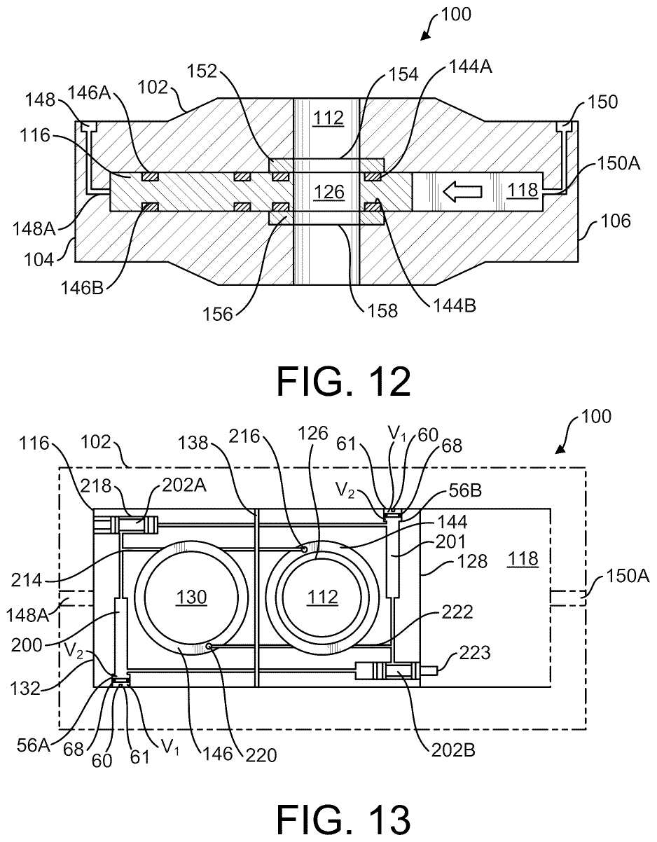

FIG. 12 shows a cross section of a gate 100 embodiment according to this disclosure. As depicted in FIG. 12, the first and second seal assemblies 144, 146 may be implemented with conventional radial seals 144A, 144B, 146A, 146B (see FIG. 11) to restrict fluid passage between the through bore 112 and the slot 118. Some embodiments may also be implemented with the seals 144A, 144B, 146A, 146B configured for energization to urge the respective seal faces against the surfaces to be sealed, such as the seal 10 embodiments disclosed herein. Other seals 10 that may be used to implement embodiments of this disclosure are described in Intl. Pat. Apps. WO20211142004 and WO20211141999.

FIG. 12 also shows a first fluid port 148 leading to an internal fluid passage 148A that traverses the valve 100 body 102 to provide a fluid feed to the slot 118 at the first end 104. A second fluid port 150 is disposed at the second end 106 of the valve 100 and leads to another internal fluid passage 150A that traverses the valve body 102 to provide a fluid feed to the slot 118 at the second end. As shown in FIG. 12, the valve 100 is in the open position with the gate 116 abutting the slot 118 wall at the first end 104 of the valve. As described herein, in this position the gate 116 opening 126 is coincident with the through bore 112, permitting fluid flow therethrough from either end across the valve 100 body 102. The gate 116 is set in the open position by maintaining a constant fluid pressure in the slot 118 at the second end 106 via fluid passage 150A, as depicted by the arrow in FIG. 12.

To close the valve 100, fluid is introduced under pressure through the first fluid port 148 via fluid passage 148A and into the slot 118 at the first valve 100 end 104. Simultaneously, fluid pressure is released from the slot 118 at the second end 106 via second fluid port 150A. As fluid pressure at the first end 104 overcomes the pressure at the second end 106 of the slot 118, the gate 116 is pushed from the open to the closed position (left to right in the page). FIG. 10B shows a valve 100 with the gate 116 in the closed position. Although the first and second fluid ports 148, 150 are shown disposed at the first planar surface 108 of the valve 100, it will be appreciated that other embodiments may be implemented with the ports located at other surfaces (e.g., first end 104, second end 106, second planar surface 110, etc.) to facilitate mounting of the valve depending on the application.

Fluid pressure to move the gate 116 from the open-to-closed position, and vice-versa, as described herein, may be provided by a separate pump and fluid (e.g., hydraulic fluid) reservoir system coupled to the first and second fluid ports 148, 150 (see FIG. 17). As such, the valve 100 embodiments provide a closed system for the fluid to move the gate 116. FIG. 12 also shows a valve 100 embodiment configured with a first annular seat 152 disposed in a channel 154 formed in the body 102 above the gate 116 coincident with the through bore 112. A second annular seat 156 is disposed in another channel 158 formed in the body 102 below the gate 116 coincident with the through bore 112. The first and second annular seats 152, 156 may be formed of more durable materials (e.g., stainless steel, INCONEL™, ceramics, tungsten carbide, etc.) compared to the valve 100 body 102. Since sealing at the through bore 112/gate 116 junction is important to an efficient and effective valve 100, the annular seats 152, 156 provide a hardwearing corrosive-resistant surface to sustain a good seal via the seal assemblies 144, 146, particularly when implemented with energizable seals 10. In applications with fluids containing damaging or abrasive elements (e.g., sand contamination), the combination of seals 144, 146 and seats 152, 156 provides the necessary sealing to prevent migration of undesired contaminants internally within the valve 100. Placement of the seal assemblies 144, 146 on the gate 116 cartridge provides a significant advantage compared to conventional valves. Valves 100 configured with hardwearing annular seats 152, 156 can provide the required sealing ability for extended operation since the seal assemblies 144, 146 can be easily replaced in the field (without having to remove the valve 100 from the system) by extraction and refurbishment or replacement of the gate 116 cartridge as described herein.

Turning to FIG. 13, a transparency cutaway view of the top of a valve 100 embodiment according to this disclosure is shown. Valve 100 embodiments may be implemented with the energizable seal 10 assemblies 144, 146 disclosed herein. FIG. 13 shows a gate 116 embodiment configured with internal fluid ports to channel fluid to energize the seals 10 disposed on the gate.

The valve 100 of FIG. 13 is shown in the open position, with the gate opening 126 coincident with the through bore 112. In this mode, the seals 144A, 144B of the first seal 10 assembly 144 are energized up by fluid pressure provided by a fluid reservoir 200 disposed on the gate 116 containing a suitable fluid (e.g., semi-solid compound, hydraulic fluid, etc.). When the valve 100 is in the closed position, the second seal 10 assembly 146 (on the left side of the page) is energized up. During the transition phase between open-close-open, the respectively engaged seals 10 begin to de-energize, allowing the gate 116 to move while the other seals 10 become energized.

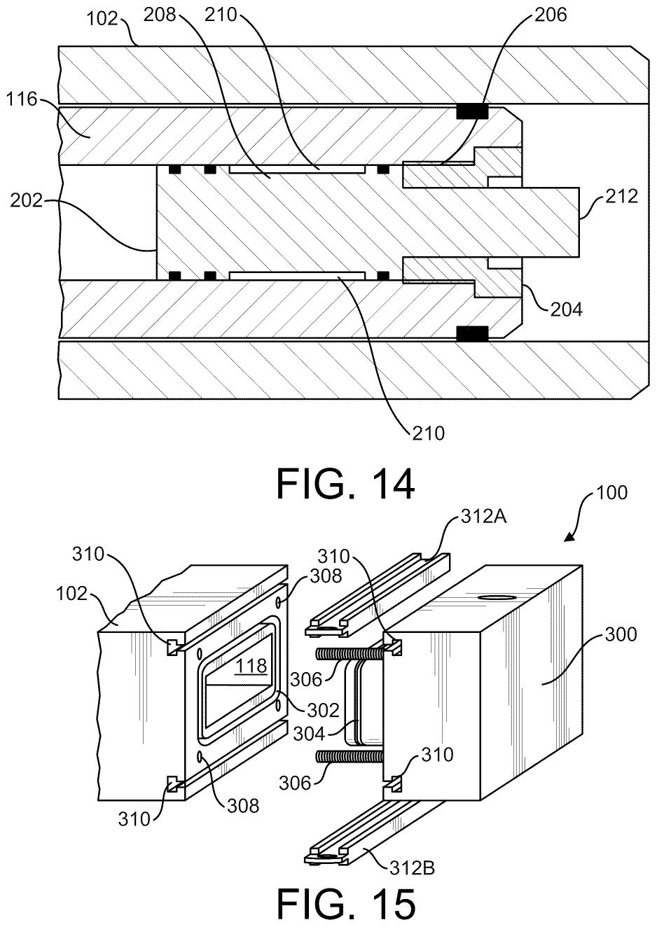

FIG. 13 shows a gate 116 embodiment configured with two fluid timing circuits. Each circuit activates one of the seal 10 assemblies 144, 146. Each circuit is implemented by a valve spool and a fluid reservoir interconnected via internal fluid ports in the gate 116. FIG. 14 shows a cross-section of a valve spool 202 embodiment according to this disclosure. The spool 202 is configured with a plug 204 that is threaded into an internal passage 206 within the gate 116 (e.g., via port 142 of FIG. 9). An internal plunger 208 provides an annular flow space 210 between sealed ends (e.g., via O-rings). When acted upon by fluid pressure or physical contact with the gate 116 body, the plunger 208 is free to move within the internal passage 206 in the gate. In one position, a distal end 212 of the plunger 208 extends outward past the end of the gate 116 (see, e.g., 223 in FIG. 13).

Returning to FIG. 13, the valve 100 is in the open position, allowing unrestricted fluid passage through the gate 116 via the opening 126/through bore 112. In this open position, a first fluid reservoir 200 in the gate 116 provides hydraulic fluid under pressure through a first internal fluid port 214 that provides an outlet 216 at the bottom surface of the seal channels 134, 134′ underneath each seal 144A, 144B to energize up or urge each seal 10 out of its channel (see FIGS. 11, 12). In this position, the second end 132 of the gate 116 is pushed up against the valve body 102 wall by the fluid pressure applied to the first end 128 of the gate via internal fluid passage 150A. The distal end of a first valve spool 202A plunger is pressed into the receiving port 218 as the gate 116 abuts the body 102 wall. With the plunger in this position, the annular flow space provided by the plunger links the internal fluid passages as shown to allow fluid under pressure from the first fluid reservoir 200 to flow through the outlet 216 to energize up the seals 144A, 144B.

The plunger on a second valve spool 202B is positioned to block fluid flow via the respective internal fluid ports leading to another outlet 220 at the bottom surface of the seal 10 channels 136, 136′ of the other seals 146A, 146B (see FIGS. 11, 12) to keep those seals de-energized. When activating the gate 116 from the open position (as shown in FIG. 13) to the closed position by activation fluid pressure via internal fluid passage 148A, a second fluid reservoir 201 in the gate 116 commences drawing in the fluid through the internal ports 222 to allow the fluid under the seals 144A, 144B to discharge into the reservoir, allowing the seals 10 to de-energize and retract back into their respective channels 134, 134′. Simultaneously, as the gate 116 transitions to the closed position (left to right in the page), the other seals 146A, 146B begin to energize up via fluid pressure through the internal ports as the gate 116 moves to the closed position. When the gate 116 is in the fully closed position, with the first end 128 of the gate abutting against the valve body 102 wall (right side of FIG. 13), the extended distal end 223 of the second valve spool 202B will be pressed into the receiving port to allow maximum fluid flow under pressure from the second fluid reservoir 201 to flow through the outlet 220 to energize up the seals 146A, 146B while the other seals 144A, 144B are de-energized.

The embodiment of FIG. 13 includes a first chamber 56A and a second chamber 56B formed in the gate 116. These chambers 56A, 56B each house a piston 68 configured to slide therein, separating the chamber into two volumes V1, V2, similar to the embodiment shown in FIG. 6. The chambers 56A, 56B may each be sealed with a cap 61 mounted to be flush with the gate 116 wall surface. Volume V1 of the chambers 56A, 56B may be pressurized by injecting a suitable fluid (nitrogen or other gas) through a recessed nozzle 60 on the cap 61. On the other side of the piston 68, volume V2 of the chambers 56A, 56B may contain a suitable fluid (e.g., a semi-solid compound, grease, hydraulic fluid, etc.). Volume V2 is in fluid communication with the ports (e.g., 214, 222) in the gate 116.

The pressurized chambers 56A, 56B allow the respective seals 10 (144A, 144B, 146A, 146B) to float within their respective seal channels in response to varying contact stress imposed on the seal 10 upper surfaces during operation of the valve 100. As the gate 116 transitions between open-close-open-close, the moveable pistons 68 in the chambers 56A, 56B allow the fluid in the seal 10 channels to vary in pressure (via the gate ports 214, 222 and channel outlets 216, 220) such that each channel receives the fluid to urge the seal outward from the channel and release the received fluid to permit the seal to retract into the channel in a cyclical manner as disclosed herein.

FIG. 15 shows a blowup of a valve 100 with a detachable end cap 300 embodiment according to this disclosure. As used herein for purposes of this disclosure, the words “detachment, “detached,” and “detachable” are meant to encompass a component fully separated from other components as well as a component partially separated from other components (e.g., a hinged lid, hinged door, etc.). The valve 100 body 102 embodiment of FIG. 15 shows the body end configured with a seal groove 302 to receive a radial seal 304 (e.g., O-Ring) to maintain a sealed passage 118 for the gate 116. One or more guide pins 306 may also be inserted in holes 308 formed in the end cap 300 and the valve 100 body 102 to provide increased structural stability. Valve 100 embodiments may be implemented with one detachable end cap 300 disposed solely at one end thereof or with a pair of end caps, each mounted at an opposing end of the valve body. Embodiments implemented with a pair of end caps 300 facilitate the removal and insertion of the gate 116 from either end of the valve 100 body 102.

As shown in FIG. 15, an embodiment may be implemented with H-channels 310 formed transversely to the longitudinal axis of the body 102 on each end of the body and the end cap 300. When the end cap 300 is fitted against the valve 100 body, a pair of elongated I-bars 312A, 312B are used to maintain the cap in place. Each I-bar 312A, 312B is inserted from one side of the body 102 to slide into place for complementary engagement within the H-channels 310 formed on the cap 300 and body 102. The I-bars 312A, 312B may be secured in place by a conventional fastener. When it is desired to replace the gate 116 cartridge (e.g., to replace all the working seals), the I-bars 312A, 312B are pulled out of the H-channels 310 to free the end cap 300 for detachment to allow access to the gate via the passage 118. Once the end cap 300 is detached, the gate 116 cartridge can be removed and replaced while keeping the valve 100 in place. It will be appreciated by those skilled in the art that other detachable end cap 300 configurations may be implemented with the valves 100 using conventional hardware means and components.

FIG. 16 shows another valve 100 embodiment of this disclosure. This embodiment is implemented with a gate 116 similar to the gate of FIG. 13, with the exception that this gate does not include pressurized chambers 56A, 56B. In this embodiment, the first 200 and second 201 fluid reservoirs are not pressurized. As shown in FIG. 16, the valve 100 includes a pair of end caps 300A, 300B coupled to a central body 102 section. The end caps 300A, 300B may be coupled to the central body 102 section in the manner shown in FIG. 15 or via any suitable means as known in the art. Each cap 300A, 300B respectively includes a first chamber 56C and a second chamber 56D formed therein. The chambers 56C, 56D each house a piston 68 configured to slide therein, separating the chamber into two volumes V1, V2, similar to the embodiment shown in FIG. 6. However, each piston 68 is configured with a stem member 57 extending from one side of the piston. The chambers 56C, 56D may each be sealed with a cap 61 mounted on the caps 300A, 330B. Volume V1 of the chambers 56C, 56D may be pressurized by injecting a suitable fluid (nitrogen or other gas) through a recessed nozzle 60 on the cap 61. On the other side of the piston 68, volume V2 of the chambers 56C, 56D may contain a suitable fluid (e.g., a semi-solid compound, grease, hydraulic fluid, etc.) or a spring. Volume V2 is sealed via conventional seals (e.g., O-rings). As shown in FIG. 16, the chambers 56C, 56D are formed in the caps 300A, 300B such that when the caps are coupled to the central body 102 section of the valve 100, the piston 68 stem members 57 are respectively aligned with the distal ends of the first 202A and second 202B valve spools.

FIG. 16 shows the valve 100 in the open position. In this position, the second end 132 of the gate 116 is abutting the inner surface of the end cap 300A. The piston 68 stem member 57 in this cap 300A is also abutting against the plunger in the first valve spool 202A. The floating piston 68 in the chamber 57C has receded into the chamber to allow the valve spool 202A plunger to move in and out of the receiving port 218 to, in turn, provide the cycling fluid pressure to the respective seal 10 channels to affect the seals 10 as disclosed herein. The plunger 223 in the second valve spool 20B at the other end of the gate 116 is extended as described above, ready to abut against the extended stem member 57 of the piston 68 in end cap 300B when the gate cycles to the closed position as disclosed herein. The chambers 57C, 57D can be pressurized after the end caps 300A, 300B are coupled to the valve 100 body. It will be appreciated that other valve 100 embodiments of this disclosure may be implemented with the gate 116 timing circuits (i.e., ports, reservoirs, chambers, spools) laid out in different configurations and with one or multiple pressurized chambers to perform the disclosed functionalities.

The disclosed fluid timing circuits channel the internal gate 116 fluids in this manner as the valves 100 cycle through open-closed sequences. The closed fluid system providing the fluid pressure to move the gate 116 back and forth (e.g., via ports 148A, 150A) and the self-contained gate 116 fluid timing circuits in essence comprise a hydraulics-over-hydraulics closed system, which aids in keeping the fluids free of contaminants.

By maintaining a good seal while the valve 100 is set in the open or closed position and while the gate 116 is in transition, the variable fluid pressure provided to the seal channels via the floating pistons ensures maximum protection is provided against undesired contaminant migration, For example, when flowing fluids with high sand concentrations, the timed energization and floating seal 10 assemblies keep the sand in the through bore 112 from migrating into the valve body 102. By preventing such ingress of debris into the valve 100 body the effective operational life of the valve is extended.

FIG. 17 shows a valve 100 embodiment of this disclosure implemented in a fluid flow system 400 (e.g., an oilfield fracking operation). The fluid supply to move the gate 116 in the valve 100, as disclosed herein, may be provided via supply lines 402, 404 in the system 400. Other embodiments may be implemented with the valve 100 configured with its own independent fluid reservoir and pump unit to provide the required fluid pressure to the gate 116. Valve 100 embodiments may also be implemented with a conventional controller 406 and software as known in the art to activate the fluid flow to operate the gate 116. Some embodiments may also be implemented with a conventional antenna for wireless remote valve 100 activation via the controller 406.

It will be appreciated that embodiments of the disclosed valves 100 may be implemented for use in numerous applications and operations, in the oil and gas industry and in other fields of endeavor. For example, the disclosed valve 100 embodiments may be deployed for use at surface, above surface, subsurface, and under water. It will be appreciated by those skilled in the art that embodiments of this disclosure may be implemented with conventional hardware components (e.g., conventional fasteners, seals, valve spools, etc.) and parts formed of suitable materials depending on the application. It will also be appreciated that embodiments may be implemented with control units locally or remotely linked to the valves 100 as known in the art. The control unit(s) may comprise any suitable microcomputer, processor, controllers, memory, and associated electronics, and may be programmed to activate and operate the valves 100 as described herein. In some embodiments, the control unit can be programmed to perform autonomous and automatic actuation of the valves and components as described herein. Power for the apparatus and valve 100 systems may also be implemented, for example, using conventional batteries as known in the art. Although only a few examples have been described in detail above, those skilled in the art will readily appreciate that many modifications are possible in the examples. Accordingly, all such modifications are intended to be included within the scope of this disclosure.

What is claimed is:

1. A valve, comprising:
a body;
a gate disposed in the body,
wherein the gate is configured for motion between a position to permit fluid flow through the body and a position to restrict fluid flow through the body;
at least one seal disposed in at least one channel on the gate,
wherein the at least one channel is configured to:
a) receive a fluid to urge the at least one seal outward from the channel;
b) release the received fluid to permit the at least one seal to retract into the channel;
and
c) cycle between (a) and (b).

2. The valve of claim 1, wherein the at least one seal is configured as a closed loop.

3. The valve of claim 1, wherein the at least one channel is in fluid communication with a reservoir configured to affect a fluid pressure to facilitate the release of the fluid from the at least one channel.

4. The valve of claim 3, wherein the reservoir is in fluid communication with a chamber including a moveable piston disposed therein to affect the fluid pressure.

5. The valve of claim 1, further comprising a moveable piston configured to affect a fluid pressure to facilitate the release of the fluid from the at least one channel.

6. The valve of claim 5, wherein the moveable piston is disposed on the gate.

7. The valve of claim 5, wherein the moveable piston is disposed on the body.

8. The valve of claim 5, wherein the moveable piston is disposed on a cap coupled to the body.

9. The valve of claim 1, wherein the at least one channel is in fluid communication with a reservoir configured to affect a fluid pressure to facilitate conveyance of the fluid for receipt by the channel to urge the at least one seal outward.

10. The valve of claim 9, wherein the reservoir is in fluid communication with a chamber including a moveable piston disposed therein to affect the fluid pressure.

11. The valve of claim 1, further comprising a moveable piston configured to affect a fluid pressure to facilitate conveyance of the fluid for receipt by the channel to urge the at least one seal outward.

12. The valve of claim 11, wherein the moveable piston is disposed on the gate.

13. The valve of claim 11, wherein the moveable piston is disposed on the body.

14. The valve of claim 11, wherein the moveable piston is disposed on a cap coupled to the body.

15. The valve of claim 1, further comprising a plurality of seals with each seal disposed in one of a plurality of channels on the gate, wherein each channel is configured to:
a) receive a fluid to urge the seal disposed therein outward from the channel;
b) release the received fluid to permit the seal disposed therein to retract into the channel; and
c) cycle between (a) and (b).

16. The valve of claim 15, wherein each seal is configured as a closed loop.

17. The valve of claim 1, further comprising an elastomer disposed in the at least one channel proximate a lower surface of the at least one seal.

18. The valve of claim 1, wherein the body comprises an internal transverse passage and the gate is configured for motion along the passage.

19. The valve of claim 18, wherein the body is configured with a first internal passage to channel fluid to apply a first force on the gate to move the gate along the transverse passage and a second internal passage to channel fluid to apply a second force on the gate in opposition to the first force to move the gate along the transverse passage.

20. The valve of claim 1, wherein the gate is configured with a first surface and a second surface opposite the first surface, with the at least one seal disposed in the at least one channel on the first surface of the gate.

21. The valve of claim 20, further comprising at least one seal disposed in at least one channel on the second surface of the gate, wherein the at least one channel on the second surface is configured to:
a) receive a fluid to urge the at least one seal disposed therein outward from the channel;
b) release the received fluid to permit the at least one seal disposed therein to retract into the channel; and
c) cycle between (a) and (b).

22. The valve of claim 21, wherein each at least one seal is configured as a closed loop.

23. The valve of claim 1, wherein the gate is configured for motion free of any mechanical linkage.

24. A method of operating a valve having a body, comprising:
channeling a fluid to at least one seal disposed in at least one channel on a gate within the body;
wherein the gate is configured for motion between a position to permit fluid flow through the body and a position to restrict fluid flow through the body;
wherein the at least one channel is configured to:
a) receive a fluid to urge the at least one seal outward from the channel;
b) release the received fluid to permit the at least one seal to retract into the channel;
and
c) cycle between steps (a) and (b).
